(19) United States
(12) Patent Application Publication
(10) Pub. No.: US 2023/0410121 A1
(43) Pub. Date: Dec. 21, 2023

(54) FAULT RESOLUTION FOR LIGHTING FIXTURES

(71) Applicant: Integrated Illumination Systems, Inc., Morris, CT (US)

(72) Inventors: Mark Alphonse Zampini, Watertown, CT (US); Julio Angel Ramirez Berroa, Fishkill, NY (US)

(73) Assignee: Integrated Illumination Systems, Inc., Morris, CT (US)

(21) Appl. No.: 18/210,851

(22) Filed: Jun. 16, 2023

Related U.S. Application Data
(60) Provisional application No. 63/353,799, filed on Jun. 20, 2022.

(51) Int. Cl. G06Q 30/012; G06K 7/14; G06F 8/65

(52) U.S. Cl. CPC G06Q 30/012; G06K 7/1417; G06F 8/65

(57) ABSTRACT

Fault resolution for light fixtures is provided. A system can receive, from a client device via a network, an identifier of a light fixture detected by the client device. The system can receive, from the client device, an indication of performance of the light fixture. The system can determine, based on the identifier and the indication of performance, a status of a warranty for the light fixture. The system can generate, based on the status of the warranty, an action to improve performance of the light fixture.

### CROSS-REFERENCES TO RELATED APPLICATIONS

This application claims the benefit of priority under 35 U.S.C. § 119 to U.S. Provisional Patent Application No. 63/353,799, filed Jun. 20, 2022, which is hereby incorporated by reference herein in its entirety.

### BACKGROUND

Lighting device can be installed in various buildings, including commercial or residential. Due to the variety of lighting configurations and installations, it can be challenging to maintain lighting devices.

### SUMMARY

This technical solution is directed to fault resolution for light fixtures. Due to the large variety of light fixture configurations and installations, it can challenging to detect faults in a light fixture, and challenging to determine the appropriate action to take to remedy or resolve the fault, thereby resulting in excessive downtime of the light fixture or wasted energy utilization (e.g., electricity) by the faulty light fixture.

Systems and methods of this technical solution provides fault resolution for light fixtures. To do so, the light fixtures of this technical solution can include a code that identifies the light fixture. The code can be presented as a barcode, QR code, radio frequency ID, or other type of code. A client device can scan or otherwise detect the code. The client device can obtain additional data associated with the light fixture or installation, and package the data for transmission to a data processing system. The data processing system, such as a server of other remote computing device, can receive the packaged data from the client device via a network. Upon receiving the packaged device, the data processing system can perform a lookup in a database to determine the status of a warranty associated with the particular light fixture. The data processing system can provide the status information to the client device for display via an interface of the client device. The data processing system can further provide one or more actions to resolve the fault. The client device can receive a selection of the action to perform, and provide an indication to the data processing system of the selected action to cause the data processing system to perform the action to resolve the fault in the light fixture.

At least one aspect is directed to a system. The system can include a data processing system comprising one or more processors and memory. The data processing system can receive, from a client device via a network, an identifier of a light fixture detected by the client device. The data processing system can receive, from the client device, an indication of performance of the light fixture. The data processing system can determine, based on the identifier and the indication of performance, a status of a warranty for the light fixture. The data processing system can generate, based on the status of the warranty, an action to improve performance of the light fixture.

At least one aspect is directed to a method. The method can be performed by a data processing system comprising one or more processors and memory. The method can include the data processing system receiving, from a client device via a network, an identifier of a light fixture detected by the client device. The method can include the data processing system receiving, from the client device, an indication of performance of the light fixture. The method can include the data processing system determining, based on the identifier and the indication of performance, a status of a warranty for the light fixture. The method can include the data processing system generating, based on the status of the warranty, an action to improve performance of the light fixture.

These and other aspects and implementations are discussed in detail below. The foregoing information and the following detailed description include illustrative examples of various aspects and implementations, and provide an overview or framework for understanding the nature and character of the claimed aspects and implementations. The drawings provide illustration and a further understanding of the various aspects and implementations, and are incorporated in and constitute a part of this specification.

### BRIEF DESCRIPTION OF THE DRAWINGS

The foregoing and other objects, aspects, features, and advantages of the present disclosure will become more apparent and better understood by referring to the following description taken in conjunction with the accompanying drawings, in which:

FIG. 1 is a block diagram depicting an example system for fault resolution of light fixtures.

FIG. 2 is a block diagram of an example method for resolving faults in light fixtures.

FIG. 3 depicts an example graphical user interface for resolving faults in light fixtures.

FIG. 4 depicts an example graphical user interface for resolving faults in light fixtures.

FIG. 5 depicts an example graphical user interface for resolving faults in light fixtures.

FIG. 6 depicts an example graphical user interface for resolving faults in light fixtures.

FIG. 7 is a block diagram illustrating an architecture for a computer system that can be employed to implement elements of the systems, apparatus, graphical user interfaces, and methods described and illustrated herein, including, for example, the examples depicted in FIGS. 1-6.

The features and advantages of the present disclosure will become more apparent from the detailed description set forth below when taken in conjunction with the drawings, in which like reference characters identify corresponding elements throughout.

### DETAILED DESCRIPTION

Following below are more detailed descriptions of various concepts related to, and implementations of, methods, apparatuses, and systems of fault resolution for light fixtures. The various concepts introduced above and discussed in greater detail below may be implemented in any of numerous ways.

This technical solution is directed to fault resolution for light fixtures. Due to the large variety of light fixture configurations and installations, it can be challenging to detect faults in a light fixture, and challenging to determine the appropriate action to take to remedy or resolve the fault, thereby resulting in excessive downtime of the light fixture or wasted energy utilization (e.g., electricity) by the faulty light fixture.

For example, light fixtures can be deployed in many different settings and environments, and interconnected to various components. Some lighting applications may use multiple lighting systems to synchronously receive and transmit data. These lighting applications can include overhead lightings, refrigerator lighting, theatrical lighting, lighting strips, or other lighting appliances. The lighting applications can be implemented using one or more lighting elements, such as light emitted diodes (“LED”), fluorescent lighting, neon lighting, incandescent lighting, high-intensity discharge lighting, or halogen lighting. In some cases, the light fixtures can be powered and communicate with the components and lighting systems using Ethernet and alternating current (“AC”) power.

Systems and methods of this technical solution provide fault resolution for light fixtures. To do so, the light fixtures of this technical solution can include a code that identifies the light fixture. The code can be presented as a barcode, QR code, radio frequency ID, or other type of code. A client device can scan or otherwise detect the code. The client device can obtain additional data associated with the light fixture or installation, and package the data for transmission to a data processing system. The data processing system, such as a server of other remote computing device, can receive the packaged data from the client device via a network. Upon receiving the packaged device, the data processing system can perform a lookup in a database to determine the status of a warranty associated with the particular light fixture. The data processing system can provide the status information to the client device for display via an interface of the client device. The data processing system can further provide one or more actions to resolve the fault. The client device can receive a selection of the action to perform, and provide an indication to the data processing system of the selected action to cause the data processing system to perform the action to resolve the fault in the light fixture.

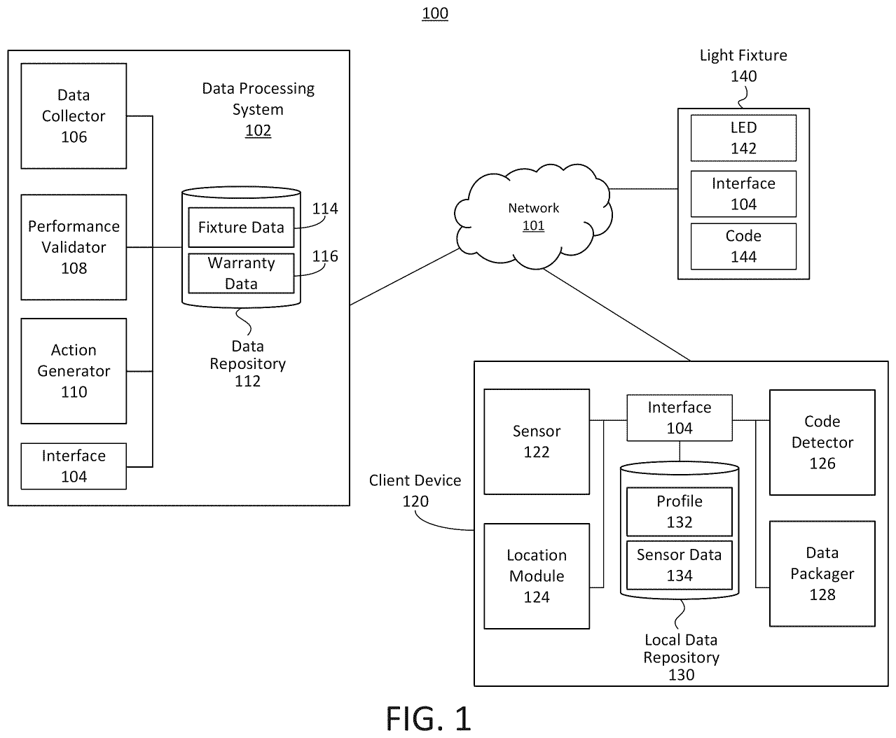

FIG. 1 is a block diagram depicting an example system 100 for fault resolution of light fixtures. The system 100 can include, interface with, or otherwise communicate with at least one data processing system 102. The system 100 can include, interface with, or otherwise communicate with at least one client device 120. The system 100 can include, interface with, or otherwise communicate with at least one light fixture 140. The data processing system 102 can communicate with the client device 120 via network 101. In some cases, the light fixture 140 can communicate with the data processing system 102 or client device 120 via network 101.

The network 101 can include computer networks such as the Internet, local, wide, metro, or other area networks, intranets, cellular networks, satellite networks, and other communication networks such as voice or data mobile telephone networks. The network 101 may be any type or form of network and may include any of the following: a point-to-point network, a broadcast network, a wide area network, a local area network, a telecommunications network, a data communication network, a computer network, an ATM (Asynchronous Transfer Mode) network, a SONET (Synchronous Optical Network) network, a SDH (Synchronous Digital Hierarchy) network, a wireless network and a wireline network. The network 101 may include a wireless link, such as an infrared channel or satellite band. The topology of the network 101 may include a bus, star, or ring network topology. The network may include mobile telephone networks using any protocol or protocols used to communicate among mobile devices, including advanced mobile phone protocol (“AMPS”), time division multiple access (“TDMA”), code-division multiple access (“CDMA”), global system for mobile communication (“GSM”), general packet radio services (“GPRS”) or universal mobile telecommunications system (“UMTS”). Different types of data may be transmitted via different protocols, or the same types of data may be transmitted via different protocols.

The light fixture 140 can refer to or include any type of lighting device, lighting apparatus, or lighting structure. The light fixture 140 can be installed indoors or outdoors. The light fixture 140 can be installed in commercial or residential settings. The light fixture 140 can be installed in retail stores, department stores, office buildings, malls, plazas, libraries, or apartment buildings, for example. The light fixture 140 can be installed in vehicles, such as automobiles or marine vehicles such as boats.

The light fixture 140 can include an LED 142 or any other light source capable of illuminating an area or providing light. The light source can provide or output light in the visible spectrum. The light fixture 140 can include an interface 104. The interface 104 can be any type of interface, such as a network interface, communication port, wired or wireless interface. The interface 104 can include a user interface, such as a switch, button, toggle, knob. In some cases, the interface 104 can include a graphical user interface. The interface 104 can be configured to receive or transmit data in accordance with a protocol, such as a communication protocol.

The light fixture 140 can include a code 144. The code 144 can include or refer to an identifier of the light fixture. The code 144 can include or refer to a unique identifier of the light fixture 140. The code 144 can be an alphanumeric code. The code 144 can include letters, numbers, symbols, or other characters that facilitate uniquely identifying the light fixture 140. The code 144 can be established by a manufacturer of the light fixture 140 or LED 142. The code 144 can be established, provided, configured, or otherwise assigned, linked, or associated with the light fixture 140 or LED 142 by an entity, administrator or operator. For example, the entity can include the manufacturer of the light fixture 140, warranty provider, or an administrator of the retail location in which the light fixture 140 is located. The code 144 can include a program or script, in some cases. The code 144 can be configured for transmission or provision to a client device 120 using one or more techniques.

For example, the code 144 can include a QR code. A QR code can refer to or include a machine-readable code. The QR code can include an array of black and white squares. The QR code can store a uniform resource locator or other identifier for the light fixture. The code 144 can include a bar code, for example.

The code 144 can be conveyed visually, such as a QR code, that can be captured or detected by a sensor 122 (e.g., camera) of the client device 120. In some cases, the code 144 can be transmitted using a radio frequency signal. For example, the code 144 can be conveyed using near-field communication (“NFC”), radio frequency identifier (“RFID”), or a Bluetooth beacon. The light fixture 140 can transmit or broadcast the code 144 via a wireless signal or protocol. The light fixture can broadcast the code responsive to a failure in the light fixture. the light fixture can broadcast the code responsive to a request from a client device 120. The light fixture can broadcast the code responsive to an interaction with the light fixture, such as the push of a button on the light fixture.

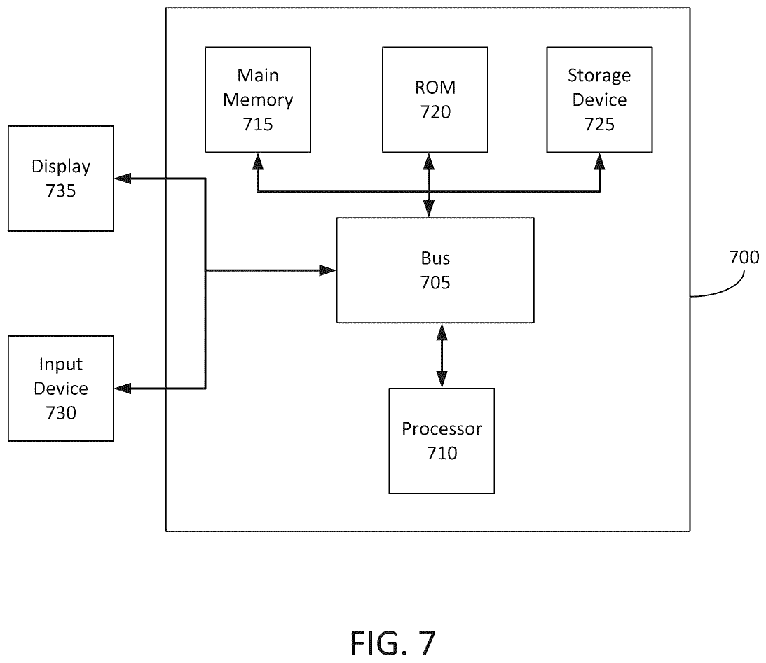

The system 100 can include, interface with, or otherwise communicate with a client device 120. The client device 120 can include one or more component depicted in FIG. 7. The client device 120 can include a mobile device, smartphone, tablet, laptop, or other computing device. The client device 120 can include at least interface 104. The client device 120 can include at least one sensor 122. The client device 120 can include at least one location module 124. The client device 120 can include at least one code detector 126. The client device 120 can include at least one data packager 128. The client device 120 can include at least one local data repository 130.

The interface 104, sensor 122, location module 124, code detector 126, or data packager 128 can each include at least one processing unit or other logic device such as a programmable logic array engine, or a module configured to communicate with the local data repository 130 or database. The interface 104, sensor 122, location module 124, code detector 126, or data packager 128 can be separate components, a single component, or part of the client device 120. The interface 104, sensor 122, location module 124, code detector 126, or data packager 128 can include hardware elements, such as one or more processors, logic devices, or circuits. For example, the interface 104, sensor 122, location module 124, code detector 126, or data packager 128 can include one or more components, structures of functionality of the computing device depicted in FIG. 7.

The local data repository 130 can include computer data storage or memory and can store one or more of a profile 132 or sensor data 134. The profile 132 can include information associated with an administrator of the light fixture 140 or client device 120. The profile 132 can be established by an operator of the client device 120 or light fixture 140. The profile 132 can include credential information or authentication information. Authentication information can include, for example, a username, user identifier, password, code, passphrase, digital token, or multi-factor authentication credentials. The profile 132 can include information associated with the installation or configuration of the light fixture 140. The sensor data 134 can include information associated with performance of the light fixture 140 or information associated with the environment in which the light fixture 140 is installed.

The sensor 122 can include, for example, a camera. The camera can take images or video of the light fixture 140, such as the code 144. The sensor 122 can include a temperature sensor, humidity sensor, pressure sensor, or ambient light sensor. The sensor 122 can collect data that can be used to determine a luminous flux or lumens of the light, flicker, or color temperature of the LED 142. The sensor 122 can include a global positioning sensor, or other location sensor. The sensor 122 can be controlled by one or more applications, programs, scripts, or components of the client device 120. For example, the client device 120 can include or execute a flicker meter application.

The client device 120 can include a location module 124 designed, constructed and operational to determine a location of the client device 120. The location module 124 can determine the location of the client device 120 at the time of detecting the code 144 (e.g., via the code detector 126). The location module 124 can determine the location indoors or outdoors. For example, the location module 124 can leverage a global positioning system to determine a geographic location, such as latitude and longitude coordinates. In some cases, the location module 124 can use cellular tower triangulation techniques, internet protocol-based location techniques, WIFI, or other location technologies to determine a location of the client device 120. In some cases, the client device 120 can leverage indoor Wi-Fi or beacons to determine the location of the client device 120 within a building.

The client device 120 can include a code detector 126 designed, constructed and operational to determine, detect, identify or otherwise obtain the code 144 of the light fixture 140. For example, if the code 144 includes a QR code, the code detector 126 can invoke a camera (e.g., sensor 122) of the client device 120 to capture an image of the code 144. The code detector 126, upon obtaining the image data captured by the camera, can parse the image or perform image recognition techniques to decipher the QR code. The code detector 126 can determine the unique identifier for the light fixture 140.

The code detector 126 can determine the code 144 of the light fixture 140 via NFC, RFID, Bluetooth beacon technology, or any other techniques. For example, the user of the client device 120 can invoke the code detector 126 and cause the code detector 126 to take a picture of the code 144. In some cases, the code detector 126 can listen for a broadcast from the light fixture 140. In some cases, the user can push a button on the light fixture 140 to broadcast the code 144, and simultaneously turn on a listen mode of the code detector 126 to detect the broadcast.

The client device 120 can include a data packager 128 designed, constructed and operational to package data collected by the client device 120 for transmission to the data processing system 102 via network 101. The data packager 128 can construct a data structure, data file or other data object that includes information associated with the light fixture 140. The data packager 128 can package information including the code 144 detected by the code detector 126. The data packager 128 can package information or data captured by the sensor 122 or location module 124. The data packager 128 can package the sensor data 134 or profile 132 information.

For example, the data packager 128 can construct a data object that includes the detected code 144, a timestamp corresponding to detection of the code, and a location determined by the client device at the timestamp. The data object can include profile 132 information, such as an identifier (e.g., username, company name, address, etc.) of the entity, operator, or administrator of the client device 120 or building in which the light fixture 140 is installed.

The data packager 128 can use one or more techniques to package the data. In some cases, the data packager 128 can be configured to compress the data in order to generate the data package. Compressing the data can result in a data package that has a file size that is less than a size of the data prior to compression. The data packager 128 can use various compression techniques or functions, including, for example, archive compression, lossy compression, or lossless compression. In some cases, the client device 120 can consolidate the location information across all light fixtures 140 at a particular retail location, and send a single indication of the location to the data processing system 102, as opposed to appending the location information to each data transmission for each light fixture 140. Since the client device 120 can be associated with the location of the light fixture 140, the data processing system 102 may have access to the same information without having to receive location information separately for each light fixture 140. By constructing a data package with a reduced file size relative to the size of the data when collected from one or more sensors or sources, the client device 120 can improve the efficiency of network transmissions and reduce network bandwidth utilization over the network 101 when communicating with the data processing system 102.

The data packager 128, upon creating the one or more data objects, can transmit the data object via one or more data packets over network 101 to the data processing system 102. The data processing system 102 can receive the data packets from client device 120 and process the data packets. The data packager 128 can transmit the data object along with a request to resolve a fault associated with the light fixture 140. For example, the data packager 128 can construct a data object with a request to resolve a fault in the light fixture 140. The data packager 128 can include performance information or indicate a performance of the light fixture 140. The indication of the performance of the light fixture 140 can include, for example, the LED 142 is out, the light is partially out, the light is flickering, or a row of lights is out.

The client device 120 can receive, via interface 104, an instruction to generate a request to resolve the fault with the light fixture 140. Responsive to the request, the client device 120 can construct the data object with the code 144, profile 132, or sensor data 134. The client device 120 can transmit the data object to the data processing system 102 responsive to the request to resolve the fault.

In some cases, the client device 120 can automatically generate the request to resolve the fault with the light fixture 140. For example, the client device 120 can be configured with a program, script, code or other component that can detect or determine a performance associated with the light fixture 140. For example, the client device 120 can include or execute one or more component or functionality of the data processing system 102, including, for example, the performance validator 108. The client device 120 can determine a performance issue associated with the light fixture 140 based on the sensor data detected or measured by sensor 122. The client device 120, responsive to determining the performance issue or fault with the light fixture 140, can generate the request to resolve the fault with the light fixture 140.

The system 100 can include, interface with, or otherwise communicate with at least one data processing system 102. The data processing system 102 can include one or more component depicted in FIG. 7. The data processing system 102 can include one or more servers, computing devices, or one or more processors and memory. The data processing system 102 can be located on a cloud computing device, server farm, or data center. The data processing system 102 can include at least one interface 104. The data processing system 102 can include at least one data collector 106. The data processing system 102 can include at least one performance validator 108. The data processing system 102 can include at least one action generator 110. The data processing system 102 can include at least one action generator 110. The data processing system 102 can include at least data repository 112 storing fixture data 114 and warranty data 116.

The interface 104, data collector 106, performance validator 108, or action generator 110 can each include at least one processing unit or other logic device such as a programmable logic array engine, or a module configured to communicate with the data repository 112 or database. The interface 104, data collector 106, performance validator 108, or action generator 110 can be separate components, a single component, or part of the data processing system 102. The interface 104, data collector 106, performance validator 108, or action generator 110 can include hardware elements, such as one or more processors, logic devices, or circuits. For example, interface 104, data collector 106, performance validator 108, or action generator 110 can include one or more components, structures of functionality of the computing device depicted in FIG. 7.

The data repository 112 can include computer data storage or memory and can store one or more of fixture data 114 or warranty data 116. Fixture data 114 can refer to or include information about the make, model, or year of the light fixture 140 associated with the code 144. Fixture data 114 can include a manufacture date of the light fixture 140, a ship date for the light fixture 140, the date the light fixture 140 was installed, or the date the light fixture 140 began operation. The fixture data 114 can include configuration information of the light fixture 140, such as the type of LED 142 or light source, power characteristics of the light source, or other performance information. Fixture data 114 can include or indicate performance history of the light fixture 140, including, for example, the amount of time the light fixture 140, or LED 142 thereof, has been in operation or turned on. Fixture data 114 can indicate an amount of wattage or lumens output by the light fixture 140.

The warranty data 116 can include a data structure or data object that stores a term of the warranty for the light fixture 140, such as the start date and expiration date of the warranty. The warranty data 116 can include conditions or constraints to satisfy the warranty. Constraints can refer to a prescribed use case or installation setting for the light fixture 140, such as geographic location, indoor use, outdoor use, power characteristics, installation requirements, operating temperature, operating humidity, etc.

The data processing system 102 can include at least one data collector 106 designed, constructed and operational to receive data from the client device 120 via network 101. The data collector 106 can receive data from one or more sources via the network 101. The data collector 106 can receive data from the light fixture 140 via the network 101. In some cases, the data collector 106 can receive data from the light fixture 140 via the client device 120.

The data collector 106 can obtain data from one or more remote data sources or devices via network 101. The data collector 106 can interface with data repositories of the data processing system 102 or the client device 120, for example. The data collector 106 can query, ping, or poll the client device 120 or light fixture 140 for data. In some cases, the data collector 106 can query the client device 120 or light fixture 140 responsive to receiving a data object or request from the client device 120 to resolve a fault with the light fixture 140. The data collector 106 can store the received data object in the data repository 112, such as in fixture data 114.

The data processing system 102 can include at least one performance validator 108. The performance validator 108 can receive the data object from the data collector 106 or fixture data 114. The performance validator 108 can determine the performance issue associated with the light fixture 140 based on the data received from the client device 120. For example, the performance can include the light is out, the light is partially out, the light is flickering, or a row of lights is out.

For example, the performance validator 108 can determine the performance of the light fixture 140 based on the luminous flux (e.g., the amount of visible light emitted by the LED 142). The luminous flux, which can be measured in lumens (lm) can indicate the brightness of the LED 142. The performance validator 108 can receive sensor data from client device that includes data indicative of the luminous flux of the light fixture 140. The performance validator 108 can compare the measured lumens with a historical lumens value for the light fixture 140 or a predetermined or threshold lumens established for the light fixture 140 (e.g., as stored in fixture data 114). If the lumens of the light fixture 140, as determined via sensor data 134, is below a the lumens threshold established for the light fixture, then the performance validator 108 can determine there is a fault associated with the light fixture 140. The threshold can be a percentage of the manufacturer indicated lumens output for the light fixture 140, or a threshold established based on historical performance of the light fixture 140, or a threshold established at a time of installation of the light fixture 140. The threshold can be an absolute value, such as lumens, or a percentage of the original lumens at the time of installation.

In some cases, the performance validator 108 can determine performance based on a color temperature of the LED 142. The color temperature can indicate or refer to a measure of the warmth or coolness of the light emitted by the LED 142 of the light fixture 140. The color temperature can be expressed in Kelvin (K). The color temperature of an LED 142 can shift or change over time, such as after a three-thousand hours of use. The performance validator 108 can receive data from client device 120 collected by sensor 122 that indicates a color temperature of light output by the LED 142 or light fixture 140. The performance validator 108 can compare the color temperature with a predetermined or established threshold color temperature for the light fixture 140. The predetermined or established threshold color temperature for the light fixture 140 can be stored in fixture data 114. The threshold color temperature can be established by the manufacturer or provider of the LED 142, or be determined based on historical use or established at the time of installation of the LED 142. For example, the installer can measure the color temperature when the LED 142 or light fixture 140 is installed, and establish this initial measurement as the desired color temperature for the light fixture 140. This desired color temperature can be stored in fixture data 114. The performance validator 108 can determine a fault with the light fixture 140 if the measured or detected color temperature varies by more than a predetermined threshold from the desired color temperature. The predetermined threshold can be a percentage (e.g., 5%, 10%, 15%, or 20%) or in units of Kelvin (e.g., 100 Kelvin, 200 Kelvin, 300 Kelvin, 400 Kelvin, or 500 Kelvin) above or below a desired color temperature. The predetermined threshold can be a range. For example, the predetermined threshold can be a range of 3500-4500 Kelvin. If the performance validator 108 determines that the measured color temperature fails or does not satisfy the threshold, or falls outside the threshold range, then the performance validator 108 can determine there is a fault with the light fixture 140, or LED 142 thereof.

The performance validator 108 can determine additional information associated with the light fixture 140 or client device 120 or request. The additional information can include, for example, the timestamp associated with the request, a location associated with the client device 120 at the time of detecting the code 144 or making the request to resolve the fault, sensor data, etc.

The performance validator 108 can determine the performance based on ambient light information received from the client device 120. The performance validator 108 can determine a flicker based on the ambient light information, or intensity of the LED 142.

The performance validator 108 can determine if the performance indication received from the client device 120 satisfies a desired performance of the light fixture 140 as stored in the fixture data 114. For example, if the temperature information received from the client device 120 is within a temperature threshold for normal operating conditions of the light fixture 140, but the performance indication is that the light is out or flickering, then the performance validator 108 can determine that there is a fault with the light fixture 140. However, if the temperature received from the client device is outside a normal operation temperature range for the light fixture 140 as stored in the fixture data 114, then the performance validator 108 can determine that the indication of the performance of the light fixture 140 is not a fault because the light fixture 140 may not have been designed, constructed and operational outside the temperature range.

The performance validator 108 can determine a fault with the light fixture 140 based on flicker. Flicker can refer to rapid and repeated changes in light intensity. The flicker can occur at a frequency that may or may not be perceptible to a human eye. The LED 142 can have a flicker index (“FI”). FI can be a measure of a magnitude of light output fluctuations over time, and can quantify an amount of flicker present in the LED 142. For example, a lower FI value can indicate less noticeable flicker, whereas a higher FI value can indicate a more noticeable flicker. The data processing system 102 or client device 120 can measure the flicker based on a flicker meter. For example, the client device 120 can launch or execute an application that functions as a flicker meter using data collected by sensor 122, which can include a light sensor or camera. The performance validator 108 can determine a fault based on the flicker index value being greater than or equal to a threshold. The threshold can include an flicker index value or a percentage. For example, if the flicker index value increases by more than 5%, 10%, 15%, or 20% from the manufacturer designed flicker index value or initial flicker index value at the time of installation of the light fixture 140 or LED 142, then the data processing system 102 can determine there is a fault.

The performance validator 108 can determine if the performance indication received from the client device 120 is an indication of a fault or an indication of operating the light fixture 140 in condition for which the light fixture was not designed, constructed or configured to operate. For example, the performance validator 108 can analyze the temperature, humidity, or pressure data associated with sensor data 134 collected by sensor 122 of the client device 120. The sensor data 134 can be transmitted to the data processing system 102 along with the request to resolve the fault. The performance validator 108 can determine, based on location information, if the light fixture 140 is installed indoors or outdoors. The performance validator 108 can determine if the light fixture 140 is installed in a geographic location outside of the established warranty zone.

Thus, the performance validator 108 can validate, verify, or confirm whether the indication of the performance received from the client device 120 corresponds to a fault in the intended use or operation of the light fixture 140, or whether the light fixture 140 is not working due to the light fixture 140 being operated in a manner for which the light fixture 140 is not designed.

The data processing system 102 can include at least one action generator 110 designed, constructed and operational to generate an action to resolve or otherwise address a fault in the light fixture 140. Example faults can include no light output or light output lumens is below a threshold lumens, flicker index value greater than a threshold, color temperature shift beyond a threshold, or excess heat being generated from an LED driver. The action generator 110 can perform a lookup in the fixture data 114 to identify one or more remedial actions based on the fault determined by the performance validator 108. For example, the action generator 110 can generate an action to cause an operator to check a power source or power cable delivering power to the light fixture 140. In some cases, the action generator 110 can automatically perform or execute an action to address, resolve, or mitigate the fault. The action generator 110 can generate an action to reset the light fixture 140 or apply a firmware update to the light fixture 140. In some cases, the action generator 110 can push an over-the-air update to the light fixture 140. To determine the action, the action generator 110 can perform a lookup in the data repository 112 or memory using the determined fault to identify a corresponding action mapped or linked to the fault that is configured to mitigate, resolve, or otherwise address the fault.

The action generator 110 can determine whether a warranty is active for the light fixture 140. For example, the action generator 110 can perform a lookup in the warranty data 116 using the code 144 to determine the status of the warranty for the light fixture 140. The status of the warranty can be active or inactive. The status can be active if the term of the warranty is still pending based on the expiration date. The status can be inactive if the expiration date of the warranty has lapsed.

In some cases, the status of the warranty can be based on the sensor data 134. For example, if the sensor data 134 indicates that the light fixture 140 is being operated under conditions for which the light fixture 140 is not designed, constructed or configured, then the action generator 110 can deactivate the warranty for the light fixture 140. The action generator 110 can update the status of the warranty data 116 for the light fixture 140 to indicate that the warranty has been voided due to the operating conditions of the light fixture 140. For example, the light fixture 140 may have been installed in a cold storage room that is kept at 35 degrees Fahrenheit, and the warranty of the light fixture 140 may have a constraint on an operating conditions above 45 degrees Fahrenheit. In this example, the data processing system 102 can receive sensor data indicating the temperature detected by the sensor 122, and can terminate or disable the warranty for the light fixture 140 based on the light fixture 140 being in a location that has a temperature of 35 degrees Fahrenheit.

In some cases, the data processing system 102 can determine whether the warranty applies to the light fixture 140 based on the location of the light fixture 140 as determined or sensed by the client device 120. For example, the client device 120 can identify the code 144 of the light fixture 140 and then determine the location, via location module 124, contemporaneously, simultaneously, or within a time interval (e.g., 5 seconds, 10 seconds, 30 seconds, 60 seconds) such that the location that is determined is proximate to the location of the light fixture 140. By determining the location of the client device 120 at the same time as scanning or detecting the code 144, the client device 120 can associate or link the location with the code of the light fixture 140, and package the data together for transmission to the data processing system 102. The warranty data 116 in the data processing system 102 can include a geofence or geographic boundaries within which the status of the warranty is inactive, and outside of which the status of the warranty becomes inactive or voided. The data processing system 102 can compare the location received from the client device 120 with the geofence established for the light fixture 140 in the warranty data 116 to determine the status of the warranty. The status can be provided to the client device 120 for display as part of status information. Should the data processing system 102 determinate to inactive or void the warranty due to the location of the light fixture 140 falling outside the geofence, or failure of other warranty constraint (e.g., ambient temperature or environmental temperature), then the data processing system 102 can change or update the expiration date to a current date.

The action generator 110 can determine, based on the validated performance and the status of the warranty, whether the warranty applies to the light fixture 140. The action generator 110 can determine to invoke the warranty to resolve the fault in the light fixture 140. The action generator 110 can determine to invoke the warranty responsive to the determination that the warranty applies to the fault of the light fixture 140. The warranty data 116 can indicate one or more actions to perform to resolve the fault. Actions in the warranty data 116 can include, for example, scheduling a technician to inspect and resolve the fault in the light fixture, ship a new light fixture 140 to the operator of the light fixture 140, or ship a component of the light fixture (e.g., LED 142).

The action generator 110 can determine whether to invoke the warranty based on authentication information received from the client device 120 based on the profile 132. For example, if the authentication information corresponds to the user or entity that established the warranty data 116 upon purchase of the light fixture 140, then the action generator 110 can determine that the warranty is still active. In some cases, the warranty may be transferrable to other operators or other locations, while in other cases the warranty may be configured to be non-transferrable.

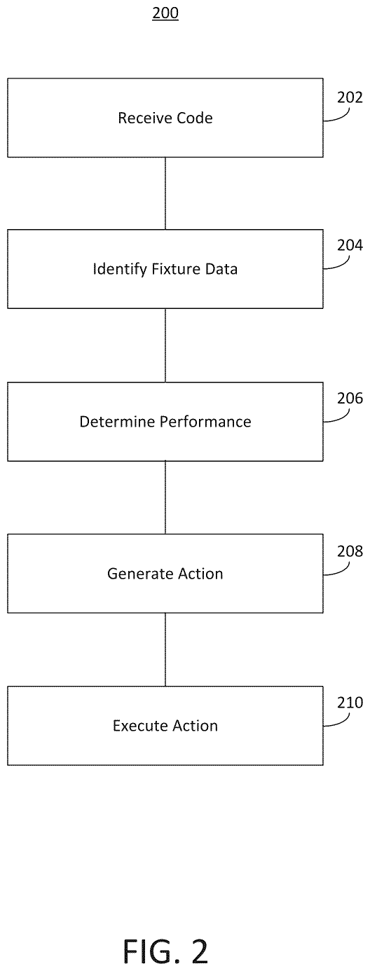

FIG. 2 is a block diagram of an example method 200 for resolving faults in light fixtures. The method 200 can be performed by one or more system or component depicted in FIG. 1 or FIG. 7, including, for example a data processing system. At ACT 202, the method 200 can include receiving a code. The data processing system can receive the code comprising an identifier of a light fixture. The data processing system can receive the code form a client device via a network. The client device can detect the code using a sensor. The client device can detect the code responsive to the client device being brought near or adjacent to the light fixture 140. In some cases, a user of the client device 120 can press a button or activate a scanner or camera on the client device 120 to cause the client device 120 to detect or obtain the code from the light fixture 140.

At ACT 204, the method 200 can include identifying fixture data. The data processing system can identify fixture information associated with the code. The fixture information can include a configuration of the light fixture, such as number of light sources, type of light sources, number of fixtures that are connected in series or parallel, type of connectors, make or model of the light fixture, LED characteristics, etc. The fixture data can include information about established performance metrics or threshold, such as a desired flicker index value, desired luminous flux, desired color temperature, or desired operating temperature. The fixture data can include threshold that, when failed, can indicate a fault with the light fixture 140.

At ACT 206, the method 200 can include determining a performance of the light fixture. The data processing system can receive an indication of the performance of the light fixture. The indication can include whether the one or more lights are out, flickering, dim, too bright, or other performance information. The data processing system can determine the fault based on the sensor data and the light fixture data. For example, the data processing system can determine a fault if the measured flicker index value exceeds a threshold flicker index value; if the luminous flux is less than a desired lumens threshold; if the color temperature falls outside a color temperature range; or if the light fixture 140 is operating at a temperature that is hotter than a threshold temperature.

At ACT 208, the method 200 can include generating an action. The data processing system can generate an action to resolve the fault. The data processing system can determine which action to take based on the type of fault, and whether a warranty for the light fixture is active and applies to the type of fault. The data processing system can automatically perform an action, such as push an over-the-air software update to the light fixture 140. In some cases, the data processing system can schedule a technician or order a part or component for the light fixture 140.

At ACT 210, the method 200 can include executing the action. The data processing system can execute the action by scheduling a technician to repair, fix or inspect the light fixture. The data processing system can execute the action by shipping a new light fixture or component thereof to the operator of the light fixture.

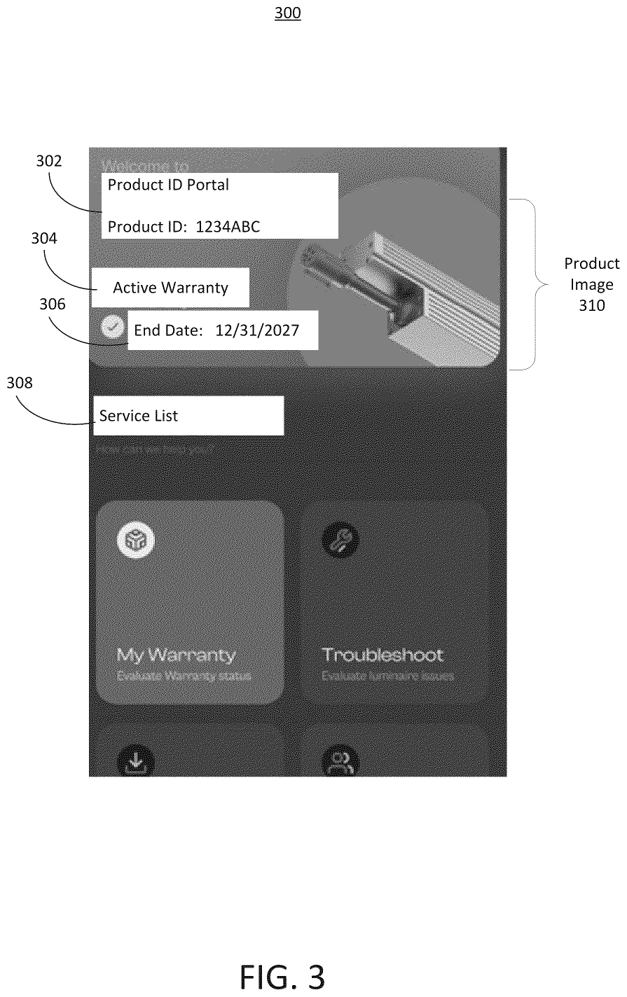

FIG. 3 depicts an example graphical user interface (“GUI”) 300 for resolving faults in light fixtures. The graphical user interface 300 can be provided by one or more system or component depicted in FIG. 1 or FIG. 7, including, for example, a data processing system or client device. For example, the data processing system can provide the information to the client device to cause the client device to render or present the GUI 300 via a display device of the client device. The GUI 300 can include an indication of the product identifier 302. The GUI 300 can display an image of the product 310. The GUI 300 can indicate whether the warranty is active 304, the end date of the warranty 306 (e.g., 12/31/2027). The GUI 300 can indicate the service list 308.

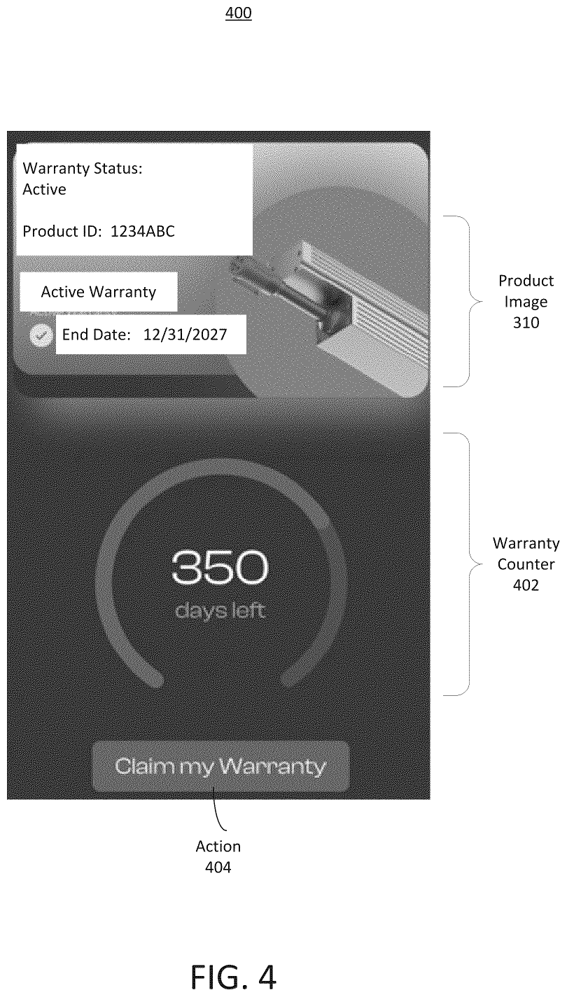

FIG. 4 depicts an example graphical user interface for resolving faults in light fixtures. The graphical user interface 400 can be provided by one or more system or component depicted in FIG. 1 or FIG. 7, including, for example, a data processing system or client device. For example, the data processing system can provide the information to the client device to cause the client device to render or present the GUI 400 via a display device of the client device. GUI 400 can reflect the warranty status as being active along with the product identifier. The GUI 400 can indicate the product image 310. The GUI 400 can provide a warranty counter 402, which can include a visual indication of the remaining duration of the warranty. The warranty counter 402 can indicate the number of days left in the warranty for the light fixture having the product ID. The warranty counter 402 can include any type of visualization. The warranty counter 402 can include at least a portion of a circle or ellipse, in which the amount of the circle or ellipse that is highlighted or filled in represent the amount or duration of the warranty left. As the duration of the warranty becomes less, the amount of the circle or ellipse that is filled in or highlighted can also become less.

The GUI 400 can present the action 404 to take, such as claim the warranty. A user of the GUI 400 can select the button 404 to trigger the action to claim the warranty. Triggering the action can include the data processing system receiving a request to claim the warranty, which can cause the data processing system to ship a new light fixture (or component thereof) or schedule a technical to inspect or repair the light fixture.

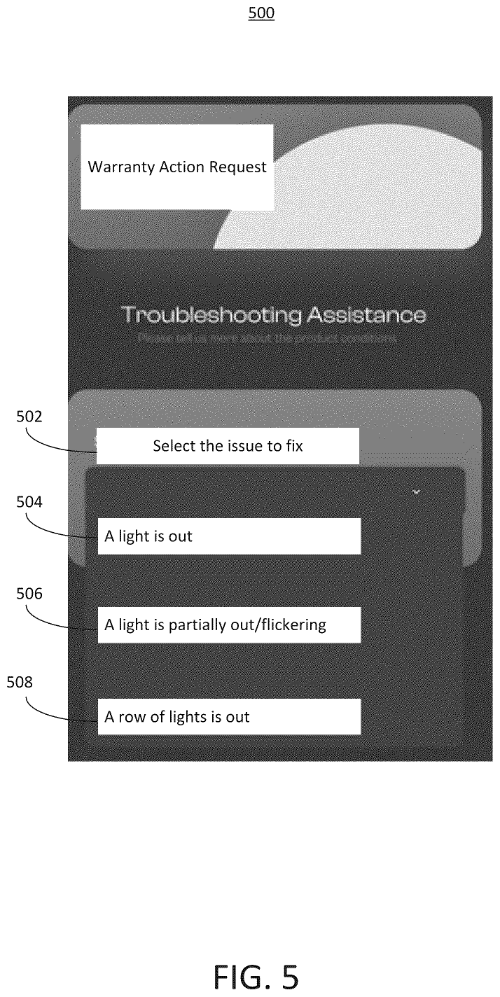

FIG. 5 depicts an example graphical user interface for resolving faults in light fixtures. The graphical user interface 500 can be provided by one or more system or component depicted in FIG. 1 or FIG. 7, including, for example, a data processing system or client device. For example, the data processing system can provide the information to the client device to cause the client device to render or present the GUI 500 via a display device of the client device. The GUI 500 can be used to determine the performance. The client device can present the GUI 500 to receive input regarding the performance. The GUI 500 can present a selection of the issue to fix 502. The indication of performance can be provided by a user of the client device. The indications of performance can include, for example, a light is out (504), a light is partially out/flickering (506), or a row of lights is out (508). The user can select one of 504, 506, or 508 to indicate the performance of the light fixture. The client device (e.g., via data packager) can package this information into a data object and transmit the data object to the data processing system for further processing. The data processing system can determine that a row of lights is out based on determining that either the light fixture corresponds to a row of lights that has a fault, or that multiple light fixtures that are configured to form a row are out or have a fault.

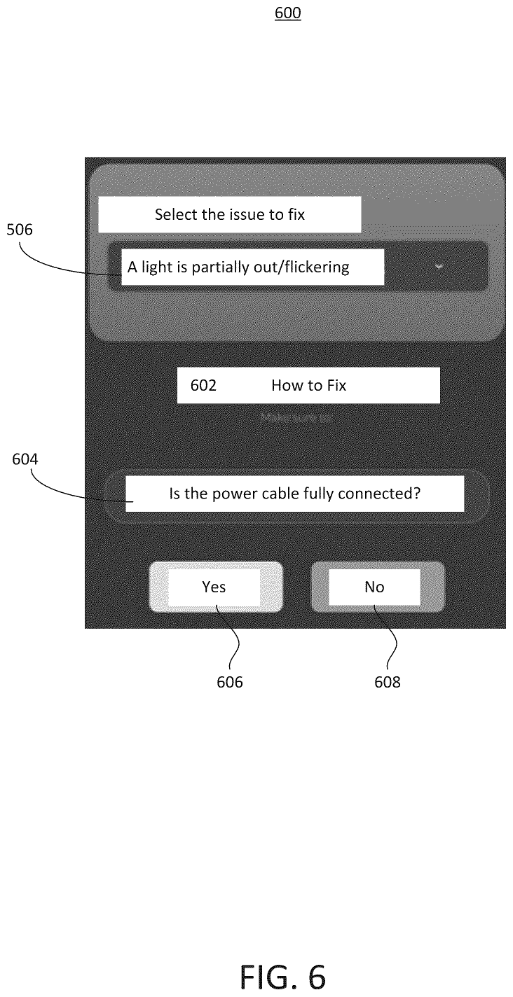

FIG. 6 depicts an example graphical user interface for resolving faults in light fixtures. The graphical user interface 600 can be provided by one or more system or component depicted in FIG. 1 or FIG. 7, including, for example, a data processing system or client device. For example, the data processing system can provide the information to the client device to cause the client device to render or present the GUI 600 via a display device of the client device. The GUI 600 can include the issue selected to be fixed in GUI 500, such as a light is partially out/flickering 506. The GUI 600 can present options for how to fix 602 the issue. The GUI 600 can present some actions to resolve the issue, such as a query to the user to check if the power cable is fully connected 604. The GUI 600 can present prompts for yes 606 or no 608 to the action 604. The performance validator of the data processing system can validate whether there is a fault with the light fixture based on the selection of yes 606 or no 608. For example, if the power cable was not fully connected, then the performance validator of the data processing system can determine that the fault is due to user error and not a fault with the light fixture for which the warranty applies. In some cases, the action generated by the data processing system can include troubleshooting-type questions that are linked or mapped or otherwise configured to address or mitigate the fault detected by the data processing system.

FIG. 7 is a block diagram of an example computer system 700. The computer system or computing device 700 can include or be used to implement the system 100 or its components such as the data processing system or client device. The computing system 700 can be used to implement the method 200 or GUIs 300, 400, 500, or 600. The computing system 700 includes a bus 705 or other communication component for communicating information and a processor 710 or processing circuit coupled to the bus 705 for processing information. The computing system 700 can also include one or more processors 710 or processing circuits coupled to the bus for processing information. The computing system 700 also includes main memory 715, such as a random access memory (RAM) or other dynamic storage device, coupled to the bus 705 for storing information, and instructions to be executed by the processor 710. The main memory 715 can be or include the data repository 112 or local data repository 130. The main memory 715 can also be used for storing position information, temporary variables, or other intermediate information during execution of instructions by the processor 710. The computing system 700 may further include a read only memory (ROM) 720 or other static storage device coupled to the bus 705 for storing static information and instructions for the processor 710. A storage device 725, such as a solid state device, magnetic disk or optical disk, can be coupled to the bus 705 to persistently store information and instructions. The storage device 725 can include or be part of the data repository 112 or 130.

The computing system 700 may be coupled via the bus 705 to a display 735, such as a liquid crystal display, or active matrix display, for displaying information to a user. An input device 730, such as a keyboard including alphanumeric and other keys, may be coupled to the bus 705 for communicating information and command selections to the processor 710. The input device 730 can include a touch screen display 735. The input device 730 can also include a cursor control, such as a mouse, a trackball, or cursor direction keys, for communicating direction information and command selections to the processor 710 and for controlling cursor movement on the display 735. The display 735 can be part of the data processing system 102, the client device 120 or other component of FIG. 1, for example.

The processes, systems and methods described herein can be implemented by the computing system 700 in response to the processor 710 executing an arrangement of instructions contained in main memory 715. Such instructions can be read into main memory 715 from another computer-readable medium, such as the storage device 725. Execution of the arrangement of instructions contained in main memory 715 causes the computing system 700 to perform the illustrative processes described herein. One or more processors in a multi-processing arrangement may also be employed to execute the instructions contained in main memory 715. Hard-wired circuitry can be used in place of or in combination with software instructions together with the systems and methods described herein. Systems and methods described herein are not limited to any specific combination of hardware circuitry and software.

Although an example computing system has been described in FIG. 7, the subject matter including the operations described in this specification can be implemented in other types of digital electronic circuitry, or in computer software, firmware, or hardware, including the structures disclosed in this specification and their structural equivalents, or in combinations of one or more of them.

The subject matter and the operations described in this specification can be implemented in digital electronic circuitry, or in computer software, firmware, or hardware, including the structures disclosed in this specification and their structural equivalents, or in combinations of one or more of them. The subject matter described in this specification can be implemented as one or more computer programs, e.g., one or more circuits of computer program instructions, encoded on one or more computer storage media for execution by, or to control the operation of, data processing apparatuses. Alternatively or in addition, the program instructions can be encoded on an artificially generated propagated signal, e.g., a machine-generated electrical, optical, or electromagnetic signal that is generated to encode information for transmission to suitable receiver apparatus for execution by a data processing apparatus. A computer storage medium can be, or be included in, a computer-readable storage device, a computer-readable storage substrate, a random or serial access memory array or device, or a combination of one or more of them. While a computer storage medium is not a propagated signal, a computer storage medium can be a source or destination of computer program instructions encoded in an artificially generated propagated signal. The computer storage medium can also be, or be included in, one or more separate components or media (e.g., multiple CDs, disks, or other storage devices). The operations described in this specification can be implemented as operations performed by a data processing apparatus on data stored on one or more computer-readable storage devices or received from other sources.

The terms “data processing system”, “client device”, “computing device” “component” or “data processing apparatus” can encompass various apparatuses, devices, and machines for processing data, including by way of example a programmable processor, a computer, a system on a chip, or multiple ones, or combinations of the foregoing. The apparatus can include special purpose logic circuitry, e.g., an FPGA (field programmable gate array) or an ASIC (application specific integrated circuit). The apparatus can also include, in addition to hardware, code that creates an execution environment for the computer program in question, e.g., code that constitutes processor firmware, a protocol stack, a database management system, an operating system, a cross-platform runtime environment, a virtual machine, or a combination of one or more of them. The apparatus and execution environment can realize various different computing model infrastructures, such as web services, distributed computing and grid computing infrastructures. For example, the action generator 110 or performance validator 108 can include or share one or more data processing apparatuses, systems, computing devices, or processors.

A computer program (also known as a program, software, software application, app, script, or code) can be written in any form of programming language, including compiled or interpreted languages, declarative or procedural languages, and can be deployed in any form, including as a stand-alone program or as a module, component, subroutine, object, or other unit suitable for use in a computing environment. A computer program can correspond to a file in a file system. A computer program can be stored in a portion of a file that holds other programs or data (e.g., one or more scripts stored in a markup language document), in a single file dedicated to the program in question, or in multiple coordinated files (e.g., files that store one or more modules, sub programs, or portions of code). A computer program can be deployed to be executed on one computer or on multiple computers that are located at one site or distributed across multiple sites and interconnected by a communication network.

The processes and logic flows described in this specification can be performed by one or more programmable processors executing one or more computer programs (e.g., components of the data processing system 102 or client device 120) to perform actions by operating on input data and generating output. The processes and logic flows can also be performed by, and apparatuses can also be implemented as, special purpose logic circuitry, e.g., an FPGA (field programmable gate array) or an ASIC (application specific integrated circuit). Devices suitable for storing computer program instructions and data include all forms of non-volatile memory, media and memory devices, including by way of example semiconductor memory devices, e.g., EPROM, EEPROM, and flash memory devices; magnetic disks, e.g., internal hard disks or removable disks; magneto optical disks; and CD ROM and DVD-ROM disks. The processor and the memory can be supplemented by, or incorporated in, special purpose logic circuitry.

The subject matter described herein can be implemented in a computing system that includes a back end component, e.g., as a data server, or that includes a middleware component, e.g., an application server, or that includes a front end component, e.g., a client computer having a graphical user interface or a web browser through which a user can interact with an implementation of the subject matter described in this specification, or a combination of one or more such back end, middleware, or front end components. The components of the system can be interconnected by any form or medium of digital data communication, e.g., a communication network. Examples of communication networks include a local area network (“LAN”) and a wide area network (“WAN”), an inter-network (e.g., the Internet), and peer-to-peer networks (e.g., ad hoc peer-to-peer networks).

The computing system such as system 100 can include clients and servers. A client and server are generally remote from each other and typically interact through a communication network (e.g., the network 101). The relationship of client and server arises by virtue of computer programs running on the respective computers and having a client-server relationship to each other. In some implementations, a server transmits data (e.g., data packets representing a data object, or digital component) to a client device (e.g., for purposes of displaying data to and receiving user input from a user interacting with the client device). Data generated at the client device (e.g., a result of measuring or receiving sensor data) can be received from the client device at the server (e.g., received by the data processing system 102 from the client device 120).

While operations are depicted in the drawings in a particular order, such operations are not required to be performed in the particular order shown or in sequential order, and all illustrated operations are not required to be performed. Actions described herein can be performed in a different order.

The separation of various system components does not require separation in all implementations, and the described program components can be included in a single hardware or software product. For example, the performance validator 108 and action generator 110 can be a single component, app, or program, or a logic device having one or more processing circuits, or part of one or more servers of the data processing system 102.

Having now described some illustrative implementations, it is apparent that the foregoing is illustrative and not limiting, having been provided by way of example. In particular, although many of the examples presented herein involve specific combinations of method acts or system elements, those acts and those elements may be combined in other ways to accomplish the same objectives. Acts, elements and features discussed in connection with one implementation are not intended to be excluded from a similar role in other implementations or implementations.

The phraseology and terminology used herein is for the purpose of description and should not be regarded as limiting. The use of “including” “comprising” “having” “containing” “involving” “characterized by” “characterized in that” and variations thereof herein, is meant to encompass the items listed thereafter, equivalents thereof, and additional items, as well as alternate implementations consisting of the items listed thereafter exclusively. In one implementation, the systems and methods described herein consist of one, each combination of more than one, or all of the described elements, acts, or components.

Any references to implementations or elements or acts of the systems and methods herein referred to in the singular may also embrace implementations including a plurality of these elements, and any references in plural to any implementation or element or act herein may also embrace implementations including only a single element. References in the singular or plural form are not intended to limit the presently disclosed systems or methods, their components, acts, or elements to single or plural configurations. References to any act or element being based on any information, act or element may include implementations where the act or element is based at least in part on any information, act, or element.

Any implementation disclosed herein may be combined with any other implementation or embodiment, and references to “an implementation,” “some implementations,” “one implementation” or the like are not necessarily mutually exclusive and are intended to indicate that a particular feature, structure, or characteristic described in connection with the implementation may be included in at least one implementation or embodiment. Such terms as used herein are not necessarily all referring to the same implementation. Any implementation may be combined with any other implementation, inclusively or exclusively, in any manner consistent with the aspects and implementations disclosed herein.

References to “or” may be construed as inclusive so that any terms described using “or” may indicate any of a single, more than one, and all of the described terms. References to at least one of a conjunctive list of terms may be construed as an inclusive OR to indicate any of a single, more than one, and all of the described terms. For example, a reference to “at least one of ‘A’ and ‘B’” can include only ‘A’, only ‘B’, as well as both ‘A’ and ‘B’. Such references used in conjunction with “comprising” or other open terminology can include additional items.

Where technical features in the drawings, detailed description or any claim are followed by reference signs, the reference signs have been included to increase the intelligibility of the drawings, detailed description, and claims. Accordingly, neither the reference signs nor their absence have any limiting effect on the scope of any claim elements.

The systems and methods described herein may be embodied in other specific forms without departing from the characteristics thereof. The foregoing implementations are illustrative rather than limiting of the described systems and methods. Scope of the systems and methods described herein is thus indicated by the appended claims, rather than the foregoing description, and changes that come within the meaning and range of equivalency of the claims are embraced therein.

Implementations of the subject matter and the operations described in this specification can be implemented in digital electronic circuitry, or in computer software, firmware, or hardware, including the structures disclosed in this specification and their structural equivalents, or in combinations of one or more of them. The subject matter described in this specification can be implemented as one or more computer programs, e.g., one or more circuits of computer program instructions, encoded on one or more computer storage media for execution by, or to control the operation of, data processing apparatus. Alternatively or in addition, the program instructions can be encoded on an artificially generated propagated signal, e.g., a machine-generated electrical, optical, or electromagnetic signal that is generated to encode information for transmission to suitable receiver apparatus for execution by a data processing apparatus. A computer storage medium can be, or be included in, a computer-readable storage device, a computer-readable storage substrate, a random or serial access memory array or device, or a combination of one or more of them. Moreover, while a computer storage medium is not a propagated signal, a computer storage medium can be a source or destination of computer program instructions encoded in an artificially generated propagated signal. The computer storage medium can also be, or be included in, one or more separate components or media (e.g., multiple CDs, disks, or other storage devices).

The term “tool” or “computing device” or “system” encompasses various apparatuses, devices, and machines for processing data, including by way of example a programmable processor, a computer, a system on a chip, or multiple ones, or combinations of the foregoing. The apparatus can include special purpose logic circuitry, e.g., an FPGA (field programmable gate array) or an ASIC (application specific integrated circuit). The apparatus can also include, in addition to hardware, code that creates an execution environment for the computer program in question, e.g., code that constitutes processor firmware, a protocol stack, a database management system, an operating system, a cross-platform runtime environment, a virtual machine, or a combination of one or more of them. The apparatus and execution environment can realize various different computing model infrastructures, such as web services, distributed computing and grid computing infrastructures.

A computer program (also known as a program, software, software application, script, or code) can be written in any form of programming language, including compiled or interpreted languages, declarative or procedural languages, and it can be deployed in any form, including as a standalone program or as a circuit, component, subroutine, object, or other unit suitable for use in a computing environment. A computer program may, but need not, correspond to a file in a file system. A program can be stored in a portion of a file that holds other programs or data (e.g., one or more scripts stored in a markup language document), in a single file dedicated to the program in question, or in multiple coordinated files (e.g., files that store one or more circuits, sub programs, or portions of code). A computer program can be deployed to be executed on one computer or on multiple computers that are located at one site or distributed across multiple sites and interconnected by a communication network.

While this specification contains many specific implementation details, these should not be construed as limitations on the scope of any inventions or of what may be claimed, but rather as descriptions of features specific to particular implementations of particular inventions. Certain features described in this specification in the context of separate implementations can also be implemented in combination in a single implementation. Conversely, various features described in the context of a single implementation can also be implemented in multiple implementations separately or in any suitable subcombination. Moreover, although features may be described above as acting in certain combinations and even initially claimed as such, one or more features from a claimed combination can in some cases be excised from the combination, and the claimed combination may be directed to a subcombination or variation of a sub combination.

Similarly, while operations are depicted in the drawings in a particular order, this should not be understood as requiring that such operations be performed in the particular order shown or in sequential order, or that all illustrated operations be performed, to achieve desirable results. In certain circumstances, multitasking and parallel processing may be advantageous. Moreover, the separation of various system components in the implementations described above should not be understood as requiring such separation in all implementations, and it should be understood that the described program components and systems can generally be integrated in a single software product or packaged into multiple software products.

Thus, particular implementations of the subject matter have been described. Other implementations are within the scope of the following claims. In some cases, the actions recited in the claims can be performed in a different order and still achieve desirable results. In addition, the processes depicted in the accompanying figures do not necessarily require the particular order shown, or sequential order, to achieve desirable results. In certain implementations, multitasking and parallel processing may be advantageous.

1. A system, comprising:
a data processing system comprising one or more processors and memory to:
receive, from a client device via a network, an identifier of a light fixture detected by the client device;
receive, from the client device, an indication of performance of the light fixture;
determine, based on the identifier and the indication of performance, a status of a warranty for the light fixture; and
generate, based on the status of the warranty, an action to improve performance of the light fixture.

2. The system of claim 1, comprising:
the data processing system to receive, from the client device, the identifier as a QR code.

3. The system of claim 1, comprising the data processing system to:
receive, from the client device, location information detected by a location sensor of the client device; and
determine the status of the warranty based on the location information.

4. The system of claim 1, comprising the data processing system to:
provide, for display via the client device, a graphical user interface; and
receive, via input from the graphical user interface, the indication of performance of the light fixture.

5. The system of claim 1, comprising the data processing system to:
receive, via the client device, sensor data collected by a sensor of the client device, the sensor data comprising ambient light information corresponding to performance of the light fixture; and
determine the performance of the light fixture based at least in part on the ambient light information.

6. The system of claim 1, comprising the data processing system to:
receive, from the client device, authentication information; and
determine the status of the warranty of the light fixture based at least in part on the authentication information.

7. The system of claim 1, comprising the data processing system to:
generate the action to push a firmware update to the light fixture.

8. The system of claim 1, comprising the data processing system to:
responsive to receipt of the indication of the performance from the client device, poll the light fixture to obtain status information;
determine a fault associated with the light fixture based on the indication and the status information; and
determine, based on the fault and the status of the warranty, to apply the warranty to improve performance of the light fixture.

9. The system of claim 1, wherein the status of the warranty comprises one of active or inactive.

10. The system of claim 1, comprising the data processing system to:
provide, for display via the client device, the status of the warranty and an expiration date of the warranty.

11. A method, comprising:
receiving, by a data processing system comprising one or more processors and memory, from a client device via a network, an identifier of a light fixture detected by the client device;
receiving, by the data processing system from the client device, an indication of performance of the light fixture;
determining, by the data processing system based on the identifier and the indication of performance, a status of a warranty for the light fixture; and
generating, by the data processing system based on the status of the warranty, an action to improve performance of the light fixture.

12. The method of claim 11, comprising:
receiving, by the data processing system from the client device, the identifier as a QR code.

13. The method of claim 11, comprising:
receiving, by the data processing system from the client device, location information detected by a location sensor of the client device; and
determining, by the data processing system, the status of the warranty based on the location information.

14. The method of claim 11, comprising:
providing, by the data processing system for display via the client device, a graphical user interface; and
receiving, by the data processing system via input from the graphical user interface, the indication of performance of the light fixture.

15. The method of claim 11, comprising:
receiving, by the data processing system via the client device, sensor data collected by a sensor of the client device, the sensor data comprising ambient light information corresponding to performance of the light fixture; and
determining, by the data processing system, the performance of the light fixture based at least in part on the ambient light information.

16. The method of claim 11, comprising:
receiving, by the data processing system from the client device, authentication information; and
determining, by the data processing system, the status of the warranty of the light fixture based at least in part on the authentication information.

17. The method of claim 11, comprising:
generating, by the data processing system, the action to push a firmware update to the light fixture.

18. The method of claim 11, comprising:
responsive to receipt of the indication of the performance from the client device, polling, by the data processing system, the light fixture to obtain status information;
determining, by the data processing system, a fault associated with the light fixture based on the indication and the status information; and
determining, by the data processing system, based on the fault and the status of the warranty, to apply the warranty to improve performance of the light fixture.

19. The method of claim 11, wherein the status of the warranty comprises one of active or inactive.

20. The method of claim 11, comprising:
providing, by the data processing system for display via the client device, the status of the warranty and an expiration date of the warranty.
